(19) United States
(12) Patent Application Publication
(10) Pub. No.: US 2004/0230681 A1
(43) Pub. Date: Nov. 18, 2004

(54) Apparatus and method for implementing network resources to provision a service using an information model

(76) Inventors: John Strassner, Colorado Springs, CO (US); Daniel J. Gannon, Sedalia, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/730,710

(22) Filed: Dec. 8, 2003

Related U.S. Application Data
(60) Provisional application No. 60/431,598, filed on Dec. 6, 2002.

(51) Int. Cl. G06F 15/173

(52) U.S. Cl. 709/226

(57) ABSTRACT

The present invention provides an apparatus and a method for provisioning services that includes configuring one or more different devices. According to a specific embodiment of the present invention, an apparatus for provisioning a service comprises an information model configured to represent a network resource of said network, to represent said service, and to represent the provisioning of said service, and a processor configured to use a subset of business rules and processes, which can be represented in the same information model, to constrain the implementation of said network resource. In accordance with another embodiment of the present invention, an exemplary apparatus and method governs the manner in which a configuration of a network device is to be created, verified, approved, and deployed.

### PRIORITY

The present nonprovisional patent application claims priority from commonly-owned U.S. patent application Ser. No. 60/431,598, filed on Dec. 6, 2002 with Attorney Docket No. CNTW-022/00US, and entitled Model-Driven System and Method for Implementing Network Provisioning Systems, which is incorporated herein by reference in its entirety for all purposes.

### RELATED APPLICATIONS

The present application is related to commonly-owned application numbers:

10/662,038, entitled System and Method for Mapping Between and Controlling Different Device Abstractions, filed Sep. 12, 2003;

09/942,834, entitled System and Method for Generating a Configuration Schema, filed Aug. 29, 2001;

09/942,833, entitled System and Method for Modeling a Network Device's Configuration, filed Aug. 29, 2001;

09/991,764, entitled System and Method for Generating a Representation of a Configuration Schema, filed Nov. 26, 2001;

10/145,868, entitled System and Method for Transforming Configuration Commands, filed May 15, 2002;

10/274,785, entitled System and Method for Managing Network Device Configurations, filed Oct. 21, 2002,

10/617,420, entitled Repository-Independent System and Method for Asset Management and Reconciliation, filed Jul. 10, 2003; and

10/213,949, entitled System and Method for Enabling Directory-Enabled Networking, filed Aug. 7, 2002,

all of which are incorporated herein by reference in their entirety for all purposes.

### FIELD OF THE INVENTION

The present invention relates to provisioning networked communication systems. In particular, but not by way of limitation, the present invention relates to apparatus and methods for using an information model to provision network resources in the activation and management of services.

### BACKGROUND OF THE INVENTION

Provisioning network services is a fundamental function of network management and can be generally described as the actions required to activate and manage a service supported by the network. Examples of such services include Virtual Private Network (“VPN”), Voice over Internet Protocol (“VoIP”), Video on Demand (“VoD”), or any other like service. The actions to activate and manage such services include many, dependent steps between the time a service is ordered and a time when that service is activated. During this interval of time, the configuration of one or more network resources (e.g., routers, etc.) is a critical task that must be performed quickly to activate an ordered service.

But conventional provisioning systems and processes are generally designed such that activities relating to both the provisioning of services and the operations processes are separate from activities relating to the network element management processes. Further, barriers in existing network management architectures prevent business processes from guiding the configuration and management of network resources. For example, consider that conventional networking management architectures, and constituent network devices, such as routers, switches, etc., as well as their configurations, are becoming increasingly complex both in structure and functionality. Due to these complexities, such device configurations are typically performed without regard to any of the business processes affected by updated configurations. This in turn impairs the ability of a network administrator to effectively control the creation, the deployment, or the modification of each device configuration in a scalable and consistent manner. As such, an organization (e.g., such as a business entity) can be without an effective means to implement or to reconfigure network resources for adapting to changes in the business processes of the organization, such as an upgrade in a service, the re-routing of a service to avoid network failures, the integration of new equipment into the network, etc.

The increased complexity in configuring a network device is, in part, due to the many functions and attendant commands, as well as the complex relationships between those commands, that are considered during the provisioning of services implementing such devices. According to contemporary provisioning models, services are scaled by manipulating the implementation of hard-wired representations of each device. Typically, these representations are composed of a pre-defined combination of: an operating system version, a vendor type, and type and model of device. As such, the resulting number of permutations for each representation is generally too numerous to be handled as individual implementations. For example, consider a case where hundreds of variations of a particular version of an operating system can be produced. The number of resulting permutations, P, is illustrated in Equation (1).

P=N×T×M×VOS, Equation(1)

where N is the number of vendors, T is the number of types of devices, M is number of models for each device, and VOS is the number of versions for the operating system.

FIG. 1 depicts an example of a common provisioning model 100. This example shows conceptually that two services are provisioned as an Internal Protocol Security (“IPsec”) VPN service 102 and a Multiprotocol Label Switching (“MPLS”) service 103. In this example, MPLS service 103 includes three variations: MPLS VPN service 104, MPLS-Traffic Engineering (“TE”) service 106 and a MPLS-Quality of Service (“QoS”) service 108. As shown, each service is shown to be “hardwired,” or connected, via wires 116 from each of translation layers 110 to each of the specific device models 112, where each specific device model 112 can represent a device 114 configured to provide support for a service.

To provision each of these services and variations thereof, a translation layer 110 is built for each service. This provisioning model gets more complicated and less scalable when one service, such as MPLS service 103, has an increasing number of different variations. By requiring a translation layer 110 for each service variation, the coordination for these different variations becomes unwieldy. Because this approach becomes unworkable as the number of services and their variations grows, conventional provisioning techniques thereby limit the number of services offered to potential customers.

As an example, consider that a particular vendor's operating system for a router (e.g., as a particular model) is made up of a very large number of distinct features and capabilities. Because each different router model has different hardware (e.g., different central processing units, or “CPUs,” and application specific integrated circuits, or “ASICs”) as well as different computing models and capacities, then different versions of an operating system are thereby required to run on each of the vendor's different network devices. As such, most current network devices limit themselves to using only a small percentage of all available commands when provisioning services.

Although present systems and techniques for provisioning network services are functional, they are not sufficiently accurate or otherwise satisfactory. Accordingly, an apparatus and method are needed to address the shortfalls of present networking provisioning technologies and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention, in the Abstract or in the Detailed Description. One skilled in the art can recognize that there are numerous modifications, equivalents and alternative constructions that fall within the spirit and scope of the invention as expressed in the claims.

The present invention provides an apparatus and a method for provisioning services and includes configuring and/or deploying one or more different devices to support provisioned services. An exemplary apparatus and method provides an information model for enabling business rules and network operations policies to drive the configuration of a network resource by, for example, translating a request to provision a service into one or more commands in a device configuration file used to implement that service. In accordance with another embodiment of the present invention, an exemplary apparatus and method governs the manner in which a configuration of a network device is to be created, verified, approved, and deployed.

According to one embodiment, an exemplary apparatus for provisioning a service using a network comprises an information model configured to implement a network resource of the network to provision the service, and a processor configured to use a subset of business rules to constrain the implementation of the network resource.

According to another embodiment, a computer-implemented method for provisioning a service using a network comprises receiving an input by a user to provision a service, and selecting a subset of network resources to provide the service based on a subset of business rules and one or more network policies, where at least two of the subset of network resources are different network resources having different programming models. In yet another embodiment, the method further comprises translating the input associated with a first representation into a second representation to implement a network resource for provisioning the service.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a diagram of a conventional provisioning model;

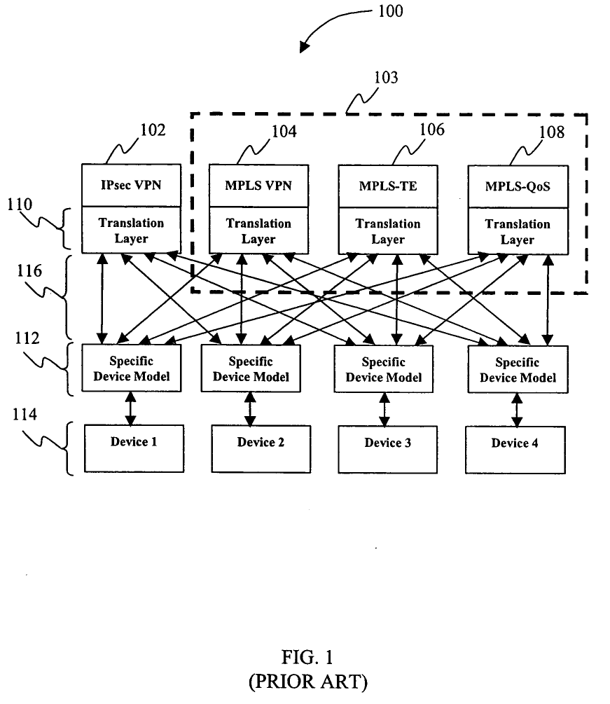

FIG. 2 illustrates an exemplary apparatus in accordance with a specific embodiment of the present invention;

FIG. 3 is an exemplary information model, according to one embodiment of the present invention;

FIG. 4 illustrates how roles of users, devices and/or external constraints affect permissions for provisioning a service in accordance with one embodiment of the present invention;

FIG. 5 depicts an exemplary provisioning model, according to a specific embodiment of the present invention;

FIG. 6 illustrates an exemplary method of organizing information according to a specific embodiment of the present invention; and

FIG. 7 illustrates an example of relating characteristics and behaviors of managed entities according to an embodiment of the present invention.

### DETAILED DESCRIPTION

The present invention provides an apparatus and a method for provisioning network services that includes configuring one or more different devices, where these different devices generally have different command syntaxes, programming models, and/or functionalities. An exemplary apparatus and method provides an information model for enabling business rules and network operations policies to drive the configuration of the network. Among other things, the information model enables an activation of a discrete business service to be translated into commands in a device configuration file used to implement that service. As such, information model of the present invention, which can be layered, enables policy management and process management techniques to symbiotically manage a network service provisioning process. In accordance with one embodiment of the present invention, an exemplary information model enables a configuration management process of the present invention to enforce how a configuration of a device is to be created, verified, approved, and deployed.

As described herein, the term “policy management” is used to describe the management of policy rules for controlling the state, or the overall behavior, of the network system as well as the interaction one or more network resources with a network. Network resources, as described herein, generally includes any network device, application, person, role, or any other element or entity associated with a particular network, and can be represented, for example, as an object. As an example, a policy management process can install and delete policy rules as well as monitor system performance to ensure that the installed policies are working correctly. Further, a policy management process can adjust policies based on feedback as to how well the network (i.e., as a provisioned service) is achieving its set of policy goals.

The term “process management” is used herein to define the management of a set of interrelated business functions, which are constrained by business rules for achieving a specific set of business goals. Two examples of business rules that an organization might seek to enforce are: (1) obtaining proper approval before network devices are provisioned, and (2) ensuring that a change is restricted to a specified time window. In general, an exemplary process management method defines a set of business processes relevant to provisioning services (e.g., business rules can define which network traffic gets priority in using shared network resources), provides the scheduling of business functions and the resources required to execute them, and enables dynamic modification of business processes based on analysis of business metrics (e.g., business rules can define how to route network traffic as set by a service level agreement, or “SLA”). Business rules can also ensure customer and service obligation are met, and other services are not affected by a newly provisioned service. Thus, business rules and the management thereof can be used to restrict any specific process of an organization, especially relating to the configuration and deployment of network devices.

A “configuration management” process, in accordance with a present invention, monitors and manages network and other operational functions. Further, a configuration management process can also monitor and manage a configuration of a device. An exemplary configuration management process tracks the identity of a person or role that changed a configuration, when it was changed, where the change was effected, why such a change was made, etc. Further, the configuration management process archives changes to each configuration to enable an element management system (“EMS”), as an example, to install a previous working version if a problem is encountered. Lastly, a configuration management process can effectuate a change to a device configuration in a manner such that other services (e.g., other services using the same device) will be not disrupted.

As described herein, an “information model” can refer to entities in a managed environment (“managed entities”) that constitute a network, the interrelationships and behavior of such managed entities, and/or how data flows within the network in a manner that is independent of how the data is stored and retrieved in a repository. An information model therefore can include abstractions and specific data, and can represent a variety of entities in a managed environment. Further, the information model can be used as a “dictionary” that defines different characteristics of managed entities and how those characteristics relate to each other. For example, an information model in accordance with a specific embodiment can be, in whole or in part, a data structure for organizing physical and logical information that describes physical and logical characteristics of managed entities. This data structure can also be used to describe how other managed entities use and are related to specific physical and logical managed assets. By using an exemplary information model of the present invention, different networking products and applications can be configured to provision a service.

Further, an exemplary information model, in accordance with at least one embodiment of the present invention, enables business rules to be translated into a form useable to define how network services are to be provisioned, such as by using device configuration commands. To effectuate the above-described process management, an exemplary information model can define a set of management and/or environmental constraints for restricting the provisioning process of the present invention. Specifically, the information model can support the configuration management process, as described above, by using business rules to provide constraints for using, configuring, monitoring and/or managing network devices. Examples of such constraints include restricting the type of user, the time of day a service is configured and/or activated, the users authorized to implement a network configuration, etc.

An exemplary information model can also support the above-described policy management processes by using a set of policies to integrate representations of the business rules with the functionality of managed entities according to the present invention. These policies can be defined, and represented, at a different level of abstraction than the business rules and managed entities (e.g., network commands). The levels of abstraction enable policies to be built so as to monitor network services and adjust, for example, the configurations of managed entities. This ensures that the business processes provided by a particular service are satisfied by the devices providing those services. The term “service” refers generally to any functionality of a network that can be provisioned for a user of a network, such as a VPN service. The term “policy” generally refers to a set of rules that are used to manage and control the changing and/or maintaining of the state of one or more managed entities.

The term “managed entity” can refer to any physical or logical entity that can be managed by a network operator, but need not represent only managed network devices. For example, a managed entity can also refer to routers, interfaces, routes, users, roles (e.g., as customer or any user of a provisioned network), applications, configuration settings, policies, statistics or to any other entity that directly or indirectly affects operation of a network device, including a subprocess associated with any network resource. In one embodiment, a managed entity can be represented by a data model that includes information for that managed entity. In another embodiment, a larger data model can represent many managed entities. In yet another embodiment, a managed entity can be represented by one or more “objects” in accordance with an object-oriented programming model.

The term “data model” can refer to any representation of the information model that defines how data is stored, manipulated and/or retrieved using a specific type of repository and access protocol. A data model, which can include data structures, operations, rules, and the like, is analogous to the implementation of the data defined in an information model, but in a particular repository that uses a particular access protocol and language to express its implementation. As an example, a router can be represented by a set of data models that represent physical and logical information that each describes one or more managed entities. In general, each data model can represent all or some of the information that describes a particular managed entity. For example, a router is typically associated with physical information (e.g., the set of line cards that are installed in the router) as well as logical information (e.g., protocols that are running on each of its interfaces). Other exemplary logical information can include protocol information, service information (e.g., connectivity using a VPN), statistical information (e.g., data describing how well a service is running), ownership information (e.g., who owns the device, who is responsible for changing the device), security information, and other like information.

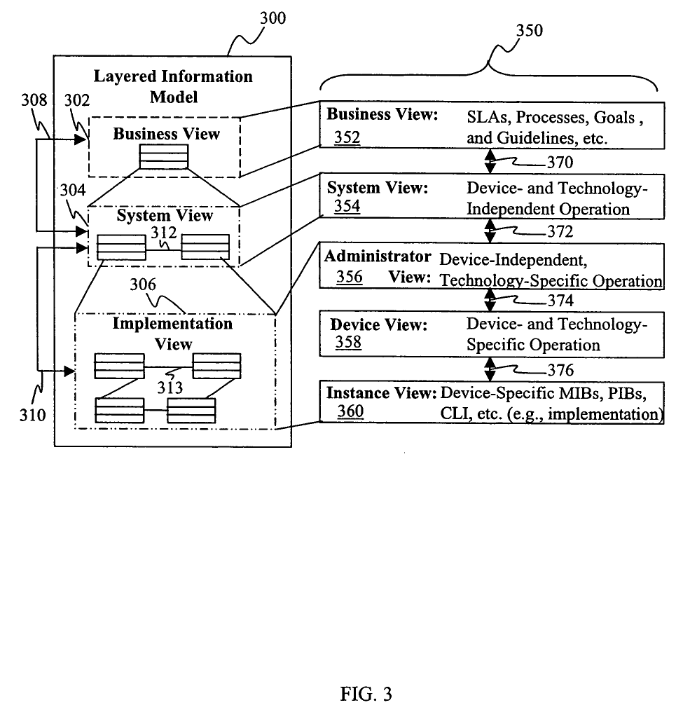

“Translating,” or “model mapping,” as described herein, can refer to translating information from one type of model to another type of model (e.g., a first data model translated to a second data model). Model mapping changes the representation and/or level of abstraction used in one model to another representation and/or level of abstraction in another model. Model mapping can refer to a mapping from an information model to a data model. This type of mapping is usually exemplified through the mapping to a standards-based data model (i.e., a data model whose constructs are based on data structures and protocol elements defined in a known standard). Model mapping can also refer to a mapping between different data models that represent different “views,” such as between a “business view” and a “device view.” The concept of “views” is described further in connection with FIG. 3. By translating between different views, the administrative capabilities of a device can be abstracted into a common representation. In turn, this common representation is used to translate high-level business rules into low-level configuration commands for provisioning a service in accordance with the present invention.

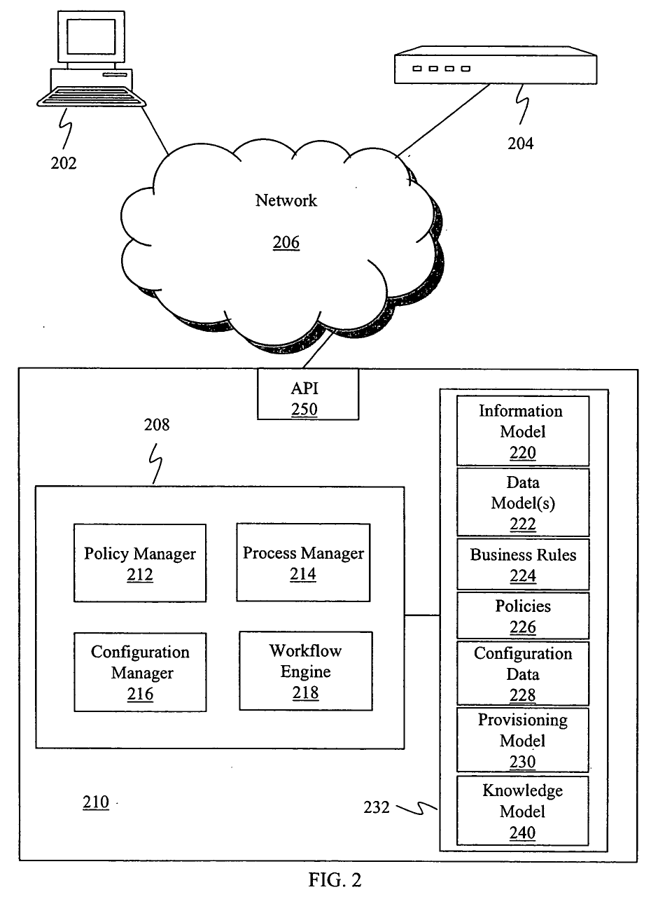

FIG. 2 illustrates an exemplary apparatus in accordance with a specific embodiment of the present invention. In the example shown, apparatus 210 is coupled to a network 206, which in turn is coupled to a computing device 202 and at least one network resource 204. Computing device 202 can be any computing device that can communicate with a network and can process a user request to apparatus 206 to, for example, provision a service. Network 206 is a communications network, such as an Ethernet network, an Internet, or any other type of communications network for exchanging data. Network resource 204 is representative of one or more network elements that can be provisioned by apparatus 210 to provide a service in accordance to the present invention. For example, network resource 204 can be a router.

Apparatus 210 is configured to at least provision network resources to support services, and as shown in FIG. 2, includes a processor 208 coupled to communicate with a storage 232. Processor 208 is configured to process requests for provisioning services and to configure network resources to provision such services. Also, processor 208 is configured to effectuate such provisions in accordance with business rules. In one embodiment of the present invention, an applications program interface (“API”) 250 is included in apparatus 210 for enabling processes (e.g., software processes) of the apparatus 210 to communicate and to exchange data with at least computing device 202. In another embodiment, API 250, or portions thereof, can be disposed in computing device 202 or any other networked computing device.

Exemplary processor 208 is composed of processor modules, such as policy manager 212, process manager 214, configuration manager 216 and workflow engine 218. Such processor modules are designed perform a process in provisioning services. Any processor module of processor 208 can be composed of software, hardware or a combination thereof, and processor 208 can include fewer or more processor modules shown in FIG. 2. In one embodiment, processor 208 is a server including one or more central processing units (“CPUs”) for providing any functionality described herein.

Storage 232 is configured store data and/or information used by one or more processor modules of processor 208 in provisioning services according to the present invention. Storage 232 can include any number of storage modules, but as shown in this example, storage 232 includes storage modules such as an information model 220, data models 222, business rules 224, policies 226, configuration data 228, a provisioning model 230 and a knowledge model 240. Any storage module of storage 232 can be composed of software, hardware or a combination thereof, and storage 232 can include fewer or more storage modules shown in FIG. 2. In one embodiment, each storage module of storage 232 represents a portion of one or more repositories or databases used generally to store data. In another embodiment, storage 232 is a single repository. Note that the functionality and/or the structure of one or more of any of the processor or storage modules shown in FIG. 2 can be combined together or distributed over the network.

Policy manager 212 and process manager 214 are configured to perform the policy management functions and the process management functions, respectively, of the present invention. Further, policy manager 212 and process manager 214 are configured to query and to receive data presenting business rules 224 and policies 226, respectively, from storage 232 (i.e., respectively from storage modules 224 and 226). Implementing policy and process management functions individually (i.e., as separate, non-symbiotic processes) in computing devices are well known and need not be discussed in detail.

But according to the present invention, apparatus 210 implements an information model 220 to combine the functions of policy management, which ensures that goals and objectives are achieved in the provisioning process, and process management, which implements the actions defined by the business rules. The combined functionality of apparatus 210 is then used to manage the provisioning process and to ensure that the provisioning process reflects the needs of the organization. In accordance with a specific embodiment, policy manager 212 uses a finite state machine to represent a set of orderly transitions between states of managed entities. These states are part of an exemplary information model 220, and enable policies to be used to express which state a given set of managed objects should be in at any given time (e.g., through a combination of events, conditions and actions). Similarly, they enable processes to be used to specify how to implement the actions specified in the policies.

Configuration manager 216 is configured to perform at least the configuration management process described above. In particular, configuration manager 216 manages the functionality of network devices. For example, configuration manager 216 can track as configuration data 228 who changed a configuration, when it was changed, where it was changed and why such a change was made. Further, configuration manager 216 can archive, as configuration data 228, changes to each configuration so that a previous working configuration can be reinstalled if a problem is encountered with an updated configuration.

In one embodiment, configuration manager 216 and/or configuration data 228 can be implemented as described in one or more of U.S. patent application Ser. Nos., 09/942,834, entitled “System and Method for Generating a Configuration Schema,” filed Aug. 29, 2001, 09/942,833, entitled “System and Method for Modeling a Network Device's Configuration,” filed Aug. 29, 2001, 09/991,764, entitled “System and Method for Generating a Representation of a Configuration Schema,” filed Nov. 26, 2001, 10/145,868, entitled “System and Method for Transforming Configuration Commands,” filed May 15, 2002, and 10/274,785, entitled “System and Method for Managing Network Device Configurations,” filed Oct. 21, 2002, all of which are incorporated by reference for all purposes.

Workflow engine 218 is configured to monitor and to manage the flow of sequential steps of configuring one or more network resources during the provisioning of a service. In particular, workflow engine 218 first manages the construction of the configuration change and then controls the deployment of such a configuration to support a provisioned service. The construction of the configuration can, for example, include selecting a person or group of people that are qualified to perform a particular configuration change (e.g., a change to a configuration file). The deployment of the changed configuration can further require: approving the changes, installing the changes, and verifying the changes. Thus, one person may only have authorization to change a configuration for a network device, such as a router, and another person might only have authorization to approve and/or implement such as change.

As such, workflow engine 218 can operate to govern device configurations implemented by configuration manager 216 in accordance with, for example, business rules 224 and/or policies 226. This enables different business rules to be applied for dictating who can construct configuration changes and who can approve, install, and/or verify how each type of configuration change is implemented. In a specific embodiment, workflow engine 218 operates using a finite state machine to represent the current state of a set of managed objects, and which states those managed objects should be in at any given time. These states are part of an exemplary information model 220. In at least one embodiment, workflow engine 218 uses “constraints” defined by information model 220 to govern the construction and the deployment of one or more configuration changes. Exemplary constraints are discussed below in connection with the discussion of information model 220.

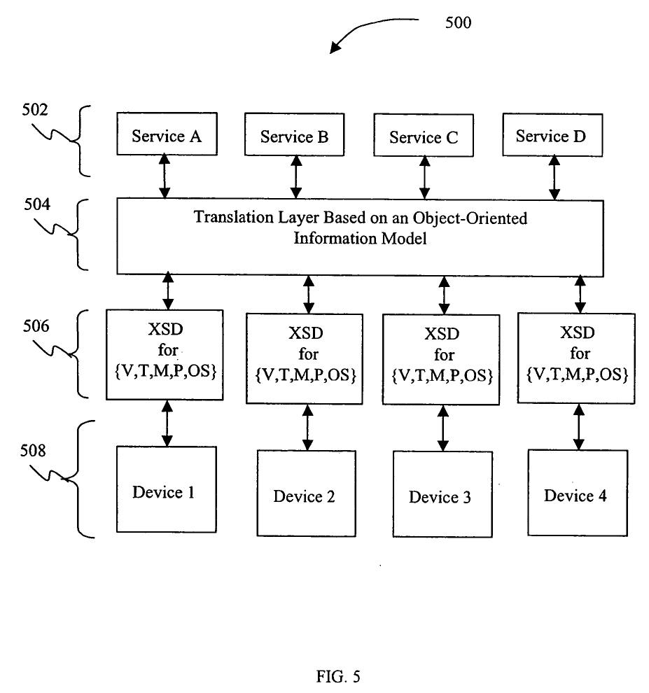

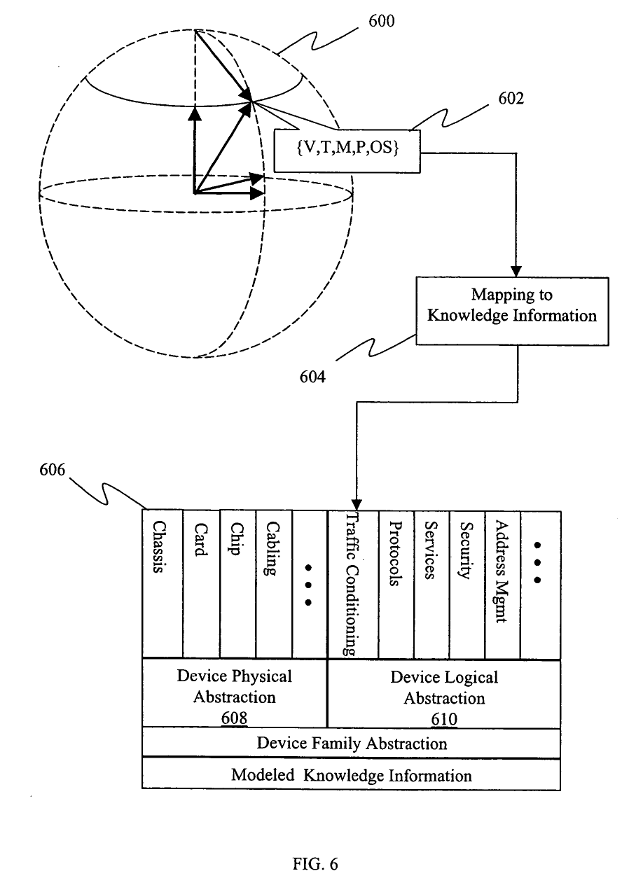

Information model 220 and data model(s) 222 are configured to provide at least those functions described above. In accordance with one or more specific embodiments of the present invention, an exemplary information model 220 and an exemplary data model 222 are discussed below in connection with FIG. 3 and FIG. 5, respectively. Provisioning model 230 is configured to provide relationships between services and network devices to translate high-level business rules to low-level device commands for facilitating the provisioning of network services. One example of provisioning model 230 according to one embodiment is described in connection with FIG. 5. Knowledge model 240 can include information for provisioning services, such as the physical and logical information characterizing a network resource. An example of knowledge model 240 according to one embodiment is described in connection with FIG. 6.

FIG. 3 is an exemplary information model of information model 220 of FIG. 2, and is represented as a set of layered information “sub-models” according to one embodiment of the present invention. Each layer of information model 300 includes a set of objects that are common to that layer, where each layer represents a different level of abstraction. Further, each layer can be a way of organizing information such that the information serves a common ontological purpose. Moreover, each of the layers is related to each other using appropriate relationships (e.g., associations, aggregations, compositions, and other like relationships). As an example, entities associated with lower layers of information model 300 can “inherit” characteristics of entities defined in its higher layers. As such, different programming models of the same device (or device feature) can be integrated and/or correlated with each other. Hence, different features that are prone to change (relative to other features associated with a network) can be isolated from each other. This allows specific feature changes in a device model (e.g., software revisions, as they are generally prone to change) to be easily accommodated by the network policies and by the business processes (e.g., as defined by business rules), depending upon those feature changes. And it also enables features that are prone to change to be separately modeled. As such, exemplary information model 300 is configured to manage objects, policies, and business rules as a homogeneous model, and it provides facilities to translate business rules and procedures of an organization to the policies that configure and control its network resources.

As shown in FIG. 3, layer 302 includes one or more objects that, for example, are defined in a business view of the managed environment. The business view includes a set of business-oriented representations (e.g., using objects) for implementing business processes, guidelines and goals. These representations are generally designed for business entities, such as customers, service, service level agreements (SLA), or other users that need not be exposed to the system level abstraction. For example, a customer is not particularly interested in learning what system-level requirements are necessary to provide a service, such as the settings of a particular internal gateway protocol (“IGP”) for routing or the protocols for establishing a VPN service, at the business level. Layer 302 is related via relationship 308 to layer 304.

In one embodiment, relationship 308 is a mapping (or a translation) of the information model from one business-oriented representation to two system-oriented representations (i.e., two system-level objects) having a relationship 312 between these two system-level objects. Translations between views, such as translation 370, represent the translational relationships between objects of different views. In this case, translation 370 represents the translational relationship between objects associated with business view 352 and objects of system view 354.

In this instance, layer 304 includes two objects that, for example, provide a system view. The system view includes a set of system-oriented representation (e.g., objects associated with system view 354) of a level of detail for managing the business processes, such as what type of VPN is necessary for implementation. These representations are generally designed for users that need not be exposed to the technology-specific aspects of a system-level abstraction. In particular, abstractions at this level and translations with this level are generic in nature and avoid choosing a specific technology such as Differentiated Services (“DiffServ”) or a specific implementation (e.g., IOS CLI over Telnet).

Further to the example shown in FIG. 3, relationship 310 is a translation, or a mapping, from the system-oriented representations to four implementation-oriented representations (i.e., four system-level objects) interrelated by relationships 314 among the four implementation-level objects. Although this example shows layer 306 including four objects, layer 306, like other layers, can include any number of objects.

As an example, these objects can include administrator-related representations (i.e., associated with administrator view 356) used to translate or to map to technology-specific implementations from the system level. Translation 372 represents the translational relationship between objects of system view 354 and objects associated with administrator view 356. As another example, these objects can include device-related representations (i.e., associated with device view 358) for mapping or translating a selected implementation into a form that is appropriate for a specific type of device. Translation 374 represents the translational relationship between objects of administrator view 356 and objects of device view 358. In addition, these objects can include instance-related representations (i.e. associated with instance view 360) to translate or to map that specific type of device to a configuration that takes into account the specific software versions, memory configuration, and other factors ancillary to the functionality of the device. Translation 376 represents the translational relationship between objects of device view 358 and objects of instance view 360.

Translations 370, 372, 374, and 376 can be built by, for example, developing a set of rules that translate information at one level of abstraction (i.e., one layer) to data at a different level of abstraction (i.e., at another layer, such as a higher layer). In accordance with a specific embodiment, the translations between views (e.g., translations 370, 372, 374, and 376) can collectively represent a common translation layer. One example of such a common translation layer is translation layer 504 of FIG. 5.

As shown in FIG. 3, each of the different “views” 350 is associated with a different level of abstraction. Views 350 can describe one or more policies, which collectively can be described as a “policy continuum,” that can be applied to the information model layers to determine the specificities of translating business needs of an organization into a particular device configuration. And the application of a specific set of policies is tailored to the needs of different domains (i.e., “knowledge domains”) of users as well as services and devices, for example. These sets of policies for each of views 350 bind the different views, such as the business-oriented, system-oriented, and implementation-oriented views, to the different levels of the information model 300. In one embodiment, views 350 (i.e., business view 352, system view 354, administrator view 356, device view 358, instance view 360, or other views, if applicable) each represent a different knowledge domain. In this case, each of the knowledge domains can be further subdivided. For example, the business view can include “product-specific”views, “customer-specific” views, “marketing/sales-specific” views, and the like. In other embodiments, views 350 can represent other entities, which can be described where view 352 is a first layer, view 354 is a second layer, view 356 is a third layer, view 358 is a fourth layer, and view 360 is a fifth layer. It should be noted that a policy continuum according to the present invention can have more or fewer layers.

According to one embodiment of the present invention, information model 220 of FIG. 2 is configured to include representation of “roles” for network resources, where such roles, as objects, can abstract features and/or the functionality of managed entities. These roles form the basis in which to apply a set of management and/or environmental “constraints” in the provisioning of network resources (i.e., in the construction and/or deployment of network devices). For example, the role of a network technician is associated with permissions at the device level (i.e., at instance view 360 of FIG. 3), whereas a business analyst might have different permissions at a higher level (i.e., at business view 352).

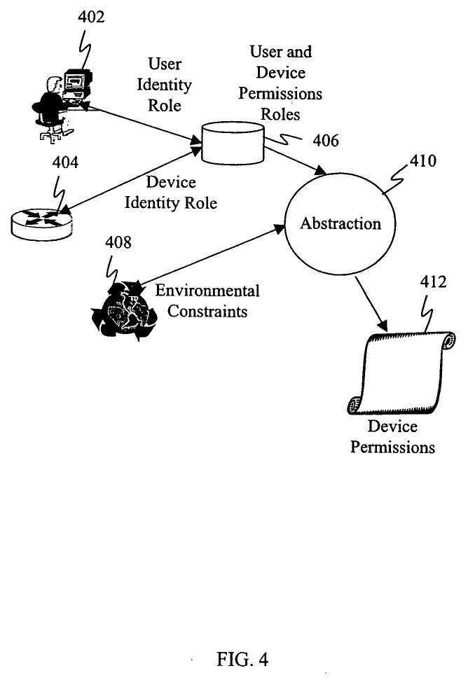

FIG. 4 illustrates how roles of users, devices and external constraints affect permissions to configure and to deploy one or more commands in provisioning a service. A user 402 can have its role, such as a network technician, defined (e.g., as a managed entity) and stored in storage module 406, which can be included in storage 232 of FIG. 2 (not shown as such). Further, a device 404, such as a router, can have its role defined (e.g., as a managed entity) and stored in a storage module 406. By intersecting a role associated with user 402 in managing device 404 using abstractions 410 of, for example, an information model, a definition of permissions 412 for that device can be implemented. Thus, such roles can be used to limit the commands that a user, a process, or an application are permitted to execute. These roles can also limit other functions associated with information model 220.

Optionally, external information 408 can affect either an intended operation (e.g., the operation cannot be performed within a certain time interval) and/or a deployment of that operation (e.g., the policy cannot be installed now within a particular time interval). Thus, according to the present invention, constraints can be imposed on the functionality available provided by apparatus 210 of FIG. 2 by some external means 408, such as business rules. Consequently, these constraints can be used to properly represent the semantics of the relationships shown in FIG. 3. In one embodiment, the use of “roles” is implemented in accordance with a DEN-next generation (“DEN-ng”) based information model. In at least one embodiment, workflow engine 218 uses the roles defined by information model 220 of FIG. 2 to restrict configuration changes carried out by configuration manager 216.

An exemplary layered object-oriented information model, according to one embodiment of the present invention, can be implemented with a common information model (“CIM”), a directory enabled network (“DEN”) information model, and/or a DEN-ng information model, or any other information model. According to this embodiment, the finite state machine(s) described above can be that of one or more of these information models. For example, the finite state machine(s) described in connection with policy manager 212 and workflow engine 218 is that of a DEN-ng based information model. Another exemplary information model suitable for practicing the present invention is described in U.S. patent application Ser. No. 10/662,038, entitled “System and Method for Mapping between and Controlling Different Device Abstractions,” filed Sep. 12, 2003 and assigned to an assignee in common with the subject application. Further, one or more data models of U.S. application Ser. No. 10/662,038 can also be used to implement data models of the present invention.

Returning to FIG. 2, data model(s) 222 can be a storage module containing one or more data models of the present invention. In a specific embodiment, one or more data model(s) 222 include representations of “knowledge” regarding particular network resources, such as network devices (e.g., a router, switch, etc). Data model(s) 222 are described further below in connection with FIG. 5.

FIG. 5 depicts an exemplary provisioning model for that shown in FIG. 2, according to a specific embodiment of the present invention. In this example, provisioning model 500 includes a common transaction layer 504 disposed between one or more services 502 that can be provisioned by a network and one or more data models 506 that, for example, replace the usual set of service-specific translation mechanisms. Common translation layer 504, as defined for example by an information model, enables multiple applications, each having different needs, to communicate using different levels of abstraction. Further, common translation layer 504 serves as input for building one or more data models 506 that represent “knowledge” for different devices 508, where such knowledge is stored in knowledge model 240 of FIG. 2. For illustrative purposes, provisioning model 230 is shown to be a separate storage module that contains relationships from a specific service to one or more network resources supporting such a service. But in accordance with another embodiment of the present invention, information model 220 can provide (and can represent) common translation layer 504, and data model(s) 222 can include (and can represent) the one or more data models 506.

In a specific embodiment, a data model 506 is implemented as an XML Schema Definition (“XSD”) to compactly represent not just information, but also the semantics of how to use that information to represent how services can be realized for one or more devices 508. An exemplary XSD data model can provide for the conversion from a XML-based command to a CLI-based command. A suitable data model to practice at least one embodiment of the present invention, as implemented as an XSD, is described in U.S. patent application Ser. No. 09/991,764, entitled “System and Method for Generating a Representation of a Configuration Schema,” filed Nov. 26, 2001, which is incorporated by reference for all purposes.

An exemplary knowledge model 240 of FIG. 2 according to one embodiment of the present invention is configured to include “knowledge” (also referred to as “configuration knowledge”) about network devices that are used to provision services. Knowledge model 240 is configured to enable different aspects of a device (e.g., its physical composition and/or its logical capabilities) to be modeled and related to each other. For example, such knowledge information can indicate the number of available ports on one or more routers (as a physical capability) that can be used to provision a service as well as the protocols available (as a logical capability) running on the interfaces of the routers. With such knowledge information, services can be provisioned without negatively affecting other provisioned services that are using the same network devices because the information model makes explicit the different relationships and dependencies between a service, the set of devices supporting that service, and even resources (e.g., memory) within a device. According to at least one embodiment, this “knowledge” information includes: a vendor (“V”) (e.g., Cisco, Juniper, etc.) which manufactured the device, a type (“T”) of device (e.g., router, LAN switch, ATM switch, etc.), a model (“M”) of the device (e.g., Cisco 7513, Cisco 7206, etc.), a product (“P”) family (e.g., a line card that can fit into any device described by a unique vendor, type, and model), operating system (“OS”) version (e.g., 12.1(5)T, etc.), or any other like information regarding a specific network resource, such as a network device.

In accordance with one embodiment of the present invention, knowledge model 240 of FIG. 2 is based on, in whole or in part, a configuration knowledge model as described in U.S. patent application Ser. Nos. 10/213,949, entitled “System and Method for Enabling Directory-Enabled Networking,” filed Aug. 7, 2002, and/or 10/617,420, entitled “Repository-Independent System and Method for Asset Management and Reconciliation,” filed Jul. 10, 2003.

FIG. 6 illustrates how knowledge can be organized according to a specific embodiment of the present invention. This knowledge can be organized and identified as a “five-tuple,” such as: {Vendor, Type of device, Product family, Model of device, Operating System}, or “{V,T,P,M,OS}” 602. As shown, a five-tuple 602 is identified along five different dimensions, where each one of the dimensions is one of the five-tuple {V,T,M,P,OS}. Therefore, any point in space 600 can represent the intersection of these five dimensions, where each dimension of the tuple can relate the physical and logical information characterizing a device. The conceptual model shown in FIG. 6 can used to provide a mapping 604 from the {V,T,M,P,OS} five-tuple 602 to knowledge information 606.

Knowledge information 606 can include the logical characteristics (e.g., traffic conditioning, protocols, services, security, address management, etc. as represented by device logical abstractions 610) and physical characteristics (e.g., chassis, card, chip, cabling, etc. as represented by device physical abstractions 608) of devices such that their features and/or composition can be abstracted into a common set of concepts and related to each other. Note that knowledge can include more or less information than is represented by such a five-tuple. That is, a set of knowledge models can be constructed to have a consistent structure for associating seemingly unrelated set of features from heterogeneous devices. These abstractions, which can be referred to as “a set of capabilities,” provide a level of normalization by which different devices having different sets of features can be compared.

The organization of logical and physical characteristics to represent a set of capabilities as a tuple is useful in provisioning a service, such as a VPN, across a set of heterogeneous devices that each has different features and functionalities. This is because normal provisioning techniques use low-level mechanisms, such as CLI or SNMP, to program a set of device interfaces to implement a high-level service. In accordance with the present invention, this task is simplified by using an object-oriented information model to relate high-level business concepts, such as a service, to system and low-level implementation concepts, such as a device configuration. Furthermore, an exemplary service provisioning method according to the present invention can use a native programming model of the device (e.g., CLI or SNMP) to accomplish the programming of the device necessary for that device to support the service.

The knowledge of knowledge model 240 of FIG. 2 can represent a set of device capabilities by providing: (1) a vendor-independent portion, and (2) extensions for modeling vendor-specific information. The vendor-independent portion enables a high-level, generic, physical composition of any type of device to be represented in a standard way. This enables any type of device to be represented in a high-level fashion, using generic concepts, which enables the provisioning process to be related to the physical composition as well as the logical configuration of the device.

The vendor-specific knowledge is formed as a set of defined extensions to the vendor-independent model. This prescribes an exemplary method for modeling different hardware, software, and services used in and supported by different vendor devices. Since vendor-specific differences can be modeled as extensions based on a single standard, these differences can be derived from a common single source. This effectively decouples vendor-specific dependencies from the overall representation of the device. Specifically, the object-oriented information model 220 of FIG. 2 can include extensions to this model as subclasses of the standard set of classes defined in information model. These subclasses inherit a set of common characteristics, including attributes and methods, which define the characteristics of one or more objects using a set of concepts that are standard across all physical devices. This enables vendor-specific extensions to be added to a fixed, common set of standard concepts.

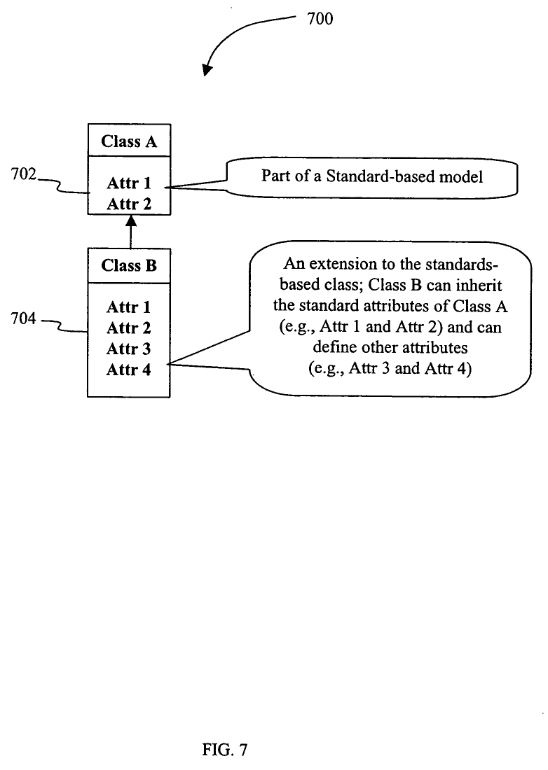

FIG. 7 illustrates an example of how standard and vendor-specific knowledge classes can be related to define characteristics and behaviors of managed entities according to an embodiment of the present invention. As shown, a vendor-specific extension 704 can be represented as “Class B,” which inherits the two attributes of “class A” defined in the standards-based model (i.e., vendor-independent model) and adds to that its own two vendor-specific attributes. Standard attributes 702 enables, for example, apparatus 210 of FIG. 2, which is compliant with a standards-based specification, to find a class instance similar to that shown in FIG. 7 even though apparatus 210 may not have been told that such a class instance exists. This is accomplished by searching for all classes that instantiate these two standards-based attributes 702. Therefore, a method of a specific embodiment is very flexible and inherently extensible, so that vendors can at any time develop their own vendor-specific models for incorporation with information model 220 of FIG. 2.

For example, consider two similarly constructed devices whose logical functionality differs because they use different networking cards. Instead of becoming lost in the differences between two different networking cards, a common single abstraction of “Card,” can be defined by, for example, a DEN-ng information model, and a subclass can represent vendor-specific features. The abstraction and subclass then can enable the new functionality of such a card to be represented. Note the extensibility of this approach—any new card could be built later after the DEN-ng information model was completed, but yet this approach is capable of representing knowledge for these new cards.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using XML, Java, C++, or other object-oriented programming language and development tools. Another embodiment of the invention may be implemented in hardwired circuitry in place of, or in combination with, machine-executable software instructions.

In conclusion, the present invention provides, among other things, a system and method for securing network devices and network-device configurations. Those skilled in the art can readily recognize that numerous variations and substitutions may be made in the invention, its use and its configuration to achieve substantially the same results as achieved by the embodiments described herein. For example, other access rights, such as “open,” “execute,” “move,” etc., and other actions, such as synchronization of files and/or devices, one or more instructions of a command set, etc., can be used to supplement the enforcement of the security set definitions described herein. Accordingly, there is no intention to limit the invention to the disclosed exemplary forms. Many variations, modifications and alternative constructions fall within the scope and spirit of the disclosed invention as expressed in the claims.

What is claimed is:

1. An apparatus for provisioning a service using a network comprising:
an information model configured to represent at least one function of a network resource to provision said service, said information model configured further to represent a relationship between said service and said at least one function, and to represent a subset of policies to govern operations of said network for provisioning said service; and
a processor configured to use a subset of business rules to constrain the implementation of said at least one function of said network resource.

2. The apparatus of claim 1 further comprising a common translation layer to translate a first level of abstraction for said network resource to a second level of abstraction.

3. The apparatus of claim 1 further comprising a common translation layer to translate a first level of abstraction for said network resource to any number of levels of abstraction, wherein said first level includes one or more levels of abstraction.

4. The apparatus of claim 1 wherein said subset includes at least one business rule for constraining configuration of said network resource.

5. The apparatus of claim 1 wherein said subset includes at least one business rule for constraining deployment of said network resource.

6. The apparatus of claim 1 wherein said information model comprises:
a managed entity data structure for representing said network resource;
an upper layer to provide a first level of abstraction for a first portion of said managed entity data structure; and
a lower layer to provide a second level of abstraction for a second portion of said managed entity data structure.

7. The apparatus of claim 6 wherein said first level of abstraction is associated with said subset of business rules and said second level of abstraction is associated with configuration data.

8. The apparatus of claim 1 wherein said information model comprises:
a managed entity data structure for representing said network resource;
a first subset of levels of abstraction associated with a first portion of said managed entity data structure; and
a second subset of levels of abstraction associated with a second portion of said managed entity data structure.

9. The apparatus of claim 8 wherein said first subset of levels of abstraction is associated with said subset of business rules and said second subset of levels of abstraction is associated with configuration data.

10. The apparatus of claim 7 wherein said configuration data includes at least a command to perform said at least one function of said network resource.

11. The apparatus of claim 6 wherein said information model further comprises another managed entity data structure for representing another network resource.

12. The apparatus of claim 11 wherein said managed entity data structure and said another managed entity data structure include a first role and a second role, respectively.

13. The apparatus of claim 11 wherein said another network resource is a user authorized to implement said network resource.

14. The apparatus of claim 1 wherein said information model is a directory enabled network-next generation (“DEN-ng”) information model.

15. A computer-implemented method for provisioning a service using a network, the method comprising:
receiving an input by a user to provision a service; and
selecting a subset of network resources to provide said service based on a subset of business rules and one or more network policies,
wherein at least two of said subset of network resources are different functions.

16. The method of claim 15 wherein said different functions are provided by the same device.

17. The method of claim 15 wherein said different functions are provided by different devices.

18. The method of claim 15 wherein selecting said subset of network resources comprises:
forming a first representation of a network resource independent of an implementation as defined by any vendor;
forming a second representation of said network resource dependent on said implementation as defined by a vendor; and
translating said input associated with said first representation into said second representation to implement said network resource for provisioning said service.

19. The method of claim 18 wherein said first representation is a first portion of a managed entity in an upper layer of an information model and said second representation is a second portion of said managed entity in a lower layer.

20. The method of claim 19 wherein said first portion includes a first subset of attributes defined by a standards-based information model and said second portion includes a second subset of characteristics dependent on said vendor, wherein said second subset inherits said first subset of attributes.

21. The method of claim 20 wherein said standards-based information model is a directory enabled network-next generation (“DEN-ng”) information model.

22. The method of claim 18 wherein translating said input further includes identifying a subset of commands to configure each of said subset of network resources.

23. The method of claim 15 wherein selecting said subset of network resources comprises:
organizing physical and logical characteristics of each of said subset of network resources as a tuple; and
using said tuple as a normalized representation for identifying network resources of said subset having similar physical and logical characteristics.

24. A computer-implemented method for provisioning a service using a network, the method comprising:
modeling a number of network resources to represent knowledge information of each network resource of said number of network resources, said knowledge information including physical and logical characteristics associated with each said network resource of said number; and
organizing said physical and logical characteristics as a tuple.

25. The method of claim 24 wherein said physical and logical characteristics include vendor, type of device, product family, model of device, and operating system.

26. The method of claim 24 further comprising identifying a subset of network resources to provide said service, wherein at least two of said subset of network resources are different devices.

27. The method of claim 26 further comprising:
modeling said service to represent relationships to the functions of said network resources;
selecting said service via a user interface; and
translating an object representing one of said different devices at a high-level of abstraction to another object representing said one of said different devices at a low-level of abstraction,
wherein said relationships are modeled using an information model.

28. The method of claim 27 wherein said high-level of abstraction includes a first role and said low-level of abstraction includes a second role.

29. The method of claim 28 wherein said first role is used to authorize deployment of said service and said second role is used to authorize configuration of said one of said different devices.

30. The method of claim 27 wherein said low-level of abstraction is associated with a vendor-specific command.

31. The method of claim 30 wherein said command is chosen based on said tuple.

32. The method of claim 24 wherein said knowledge information is represented by an XML Schema Definition (“XSD”) data model.
